(19) United States
(12) Patent Application Publication
(10) Pub. No.: US 2024/0311064 A1
(43) Pub. Date: Sep. 19, 2024

(54) NON-TRANSITORY STORAGE MEDIUM STORING SUPPORTING PROGRAM EXECUTABLE BY COMPUTER OF INFORMATION PROCESSING APPARATUS

(71) Applicant: BROTHER KOGYO KABUSHIKI KAISHA, Nagoya (JP)

(72) Inventors: Airi EGUCHI, Ichinomiya (JP); Yushi ICHIKAWA, Nagoya (JP); Kenju NARITA, Nagoya (JP); Yoshito HOSOMIZO, Kitanagoya (JP)

(21) Appl. No.: 18/601,316

(22) Filed: Mar. 11, 2024

(30) Foreign Application Priority Data
Mar. 13, 2023 (JP) 2023-039034
Mar. 13, 2023 (JP) 2023-039036

(51) Int. Cl. G06F 3/12; G06F 40/109

(52) U.S. Cl. CPC G06F 3/125; G06F 3/1205; G06F 3/1208; G06F 3/1256; G06F 40/109

(57) ABSTRACT

A non-transitory storage medium stores a supporting program executable by a computer of an information processing apparatus. The supporting program is configured to support a printing program of an operating system and conforms to a printer connected to the information processing apparatus. When executed by the computer, the supporting program causes the information processing apparatus to execute, when image data is inputted from the printing program in response to receiving the print instruction outputted from an application program for causing the printing program of the operating system to perform printing the image by the printer, adding header information, footer information, or both the header information and the footer information to the image data, and causing the printer to perform printing based on the image data to which the header information, the footer information, or both the header information and the footer information is added.

### REFERENCE TO RELATED APPLICATIONS

This application claims priority from Japanese Patent Applications Nos. 2023-039034 and 2023-039036 each filed on Mar. 13, 2023. The entire contents of the priority applications are incorporated herein by reference.

### BACKGROUND ART

The following disclosure relates to a non-transitory storage medium storing a supporting program that supports a control of a printer.

There has been a conventional configuration, as a technique of controlling a printer by an information processing apparatus such as a PC, in which a printer driver provided from a vendor of the printer generates image data in which information obtained from a user is arranged in a header area of a page.

### SUMMARY

Recently, a technique in which an OS standard general-purpose printing program constituting a part of an operating system (OS) controls an external printer without using the above described printer driver provided from the vendor of the printer has been commercialized. In this technique, when the OS detects the external printer, the OS establishes an association between the OS standard general-purpose printing program and the external printer. After that, in a case where an instruction for a print execution to the external printer is received, the OS standard general-purpose printing program generates print data, so that printing by the OS standard general-purpose printing program becomes available without using the printer driver provided from the vendor of the printer.

However, the above described OS standard general-purpose printing program does not have a function, what is called a header printing or a footer printing included in the previous printer driver provided from the vendor of the printer, of printing a page in which any information has been arranged in a header area which is an upper part of the page, a footer area which is a lower part of the page, or both the header area and the footer area. As a result of this, it is inconvenient to the user who uses the printer.

In one aspect of the disclosure, a non-transitory storage medium stores a supporting program executable by a computer of an information processing apparatus. The supporting program is configured to support a printing program of an operating system of the information processing apparatus. The supporting program conforms to a printer connected to the information processing apparatus. When executed by the computer, the supporting program causes the information processing apparatus to execute, when image data indicating an image to be printed, based on a print instruction, is inputted from the printing program of the operating system in response to receiving the print instruction, outputted from an application program installed on the information processing apparatus, for causing the printing program of the operating system to perform printing the image by the printer, adding header information, footer information, or both the header information and the footer information to the image data inputted from the operating system, and causing the printer to perform printing based on the image data to which the header information, the footer information, or both the header information and the footer information is added.

### BRIEF DESCRIPTION OF DRAWINGS

The objects, features, advantages, and technical and industrial significance of the present disclosure will be better understood by reading the following detailed description of the embodiments, when considered in connection with the accompanying drawings, in which:

FIG. 1 is a block diagram illustrating an outline of an electric configuration of a PC;

FIG. 2 is a view illustrating a sequence of steps of print setting;

FIG. 3 is an explanatory view illustrating a print setting screen;

FIG. 4 is an explanatory view illustrating an example of a detailed-setting screen;

FIG. 5 is an explanatory view illustrating an example of the detailed-setting screen;

FIG. 6 is a view illustrating a sequence of steps of print execution;

FIG. 7 is a view illustrating a sequence of steps of print execution;

FIG. 8 is an explanatory view illustrating an example of a detailed-setting screen;

FIG. 9 is an explanatory view illustrating an example of a font screen; and

FIG. 10 is a view illustrating a sequence of steps of print execution.

### DESCRIPTION

There will be described in details below a personal computer 1, which may be hereinafter referred to as the PC 1, using a supporting program of the embodiments, with reference to the drawings. The present disclosure discloses the supporting program executed in the PC 1.

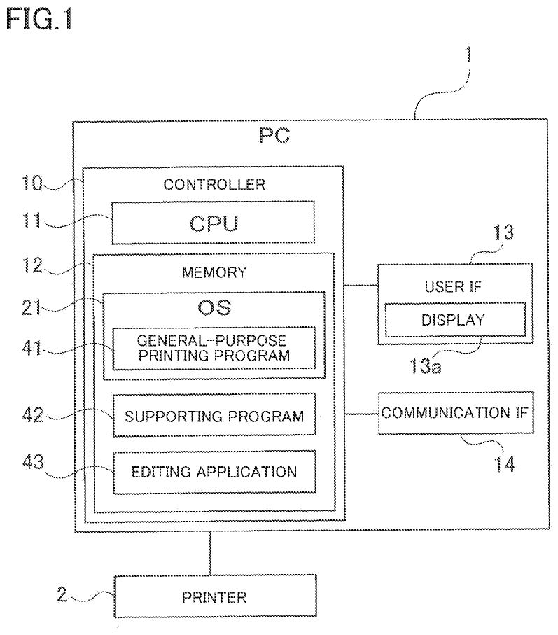

As illustrated in FIG. 1, the PC 1 of a first embodiment of the present disclosure includes a controller 10 having a CPU 11 and a memory 12. The PC 1 is an example of an information processing apparatus. The CPU 11 is an example of a computer. Moreover, the PC 1 includes a user interface 13, which may be hereinafter referred to as the user IF 13, and a communication interface 14, which may be hereinafter referred to as the communication IF 14. The user IF 13 and the communication IF 14 are electrically connected to the controller 10. It is noted that the controller 10 in FIG. 1 is a general term for hardware and software used in a control of the PC 1, and the controller 10 is not limited to a single piece of hardware actually existing in the PC 1.

The CPU 11 of the PC 1 executes various kinds of processes in accordance with various kinds of programs read from the memory 12 or based on operations by a user. The various kinds of programs and various kinds of data are stored in the memory 12. The memory 12 is also used as a work area at which the various kinds of processes are executed. A buffer in the CPU 11 is also an example of a memory. It is noted that the example of the memory 12 is not limited to a ROM, a RAM, a HDD and so on each built into the PC 1, and the example of the memory 12 may be a storage medium readable and writable by the CPU 11 such as a CD-ROM, a DVD-ROM.

The user IF 13 includes a display 13a which is hardware configured to display a screen for notifying the user of information, and hardware that receives operations by the user. It is noted that the user IF 13 may be a combination of the display 13a capable of displaying information and a mouse, a keyboard and so on each having a function of receiving an input. The user IF 13 may be a touch panel having a function of the display 13a and a function of receiving an input.

The communication IF 14 includes hardware configured to communicate with an external device such as a printer 2. Communication standard of the communication IF 14 includes Ethernet, Wi-Fi, USB and so on. Each of Ethernet, Wi-Fi, USB is a registered trademark. The PC 1 may be connectable to the Internet via the communication IF 14. The PC 1 may include a plurality of communication IFs 14 respectively conforming to a plurality of kinds of the communication standard.

As illustrated in FIG. 1, an operating system 21 including a general-purpose printing program 41 and various kinds of application programs including a supporting program 42 and an editing application 43 are stored in the memory 12 of the PC 1. The operating system 21 may be hereinafter referred to as the OS 21. The general-purpose printing program 41 is an example of a printing program. The supporting program 42 is an example of a supporting program. The editing application 43 is an example of an application program.

The OS is a multitasking operating system capable of concurrently processing a plurality of tasks by managing the plurality of tasks so as to be switched. The OS 21 is, for example, Windows, macOS, Linux, iOS or Android. Each of Windows, macOS, Linux, iOS and Android is a registered trademark.

The general-purpose printing program 41 is included in the OS 21. The general-purpose printing program 41 is prepared by a vendor of the OS 21, and is a standard program of the OS provided as a part of the OS 21. That is, the OS 21 having the general-purpose printing program 41 is installed on the PC 1. The general-purpose printing program 41 is not configured such that the general-purpose printing program 41 uses printer drivers each dedicated to each of printers.

The general-purpose printing program 41 is a program having a function of causing a plurality of kinds of models of printers which are respectively provided by a plurality of vendors to perform printing based on an instruction by a user. The general-purpose printing program 41 supports general-purpose functions of printing executable by most of the plurality of kinds of models of the printers. The general-purpose printing program 41, differing from the printer drivers each dedicated to each of the printers, does not support functions each included in each of the printer drivers or each included in each of the printers, especially, does not support functions each requiring complicated processing.

The general-purpose printing program 41 is a program having a function of receiving image data as an image to be printed designated by a print instruction outputted from each of various kinds of applications and a function of generating intermediate image data based on the image data, based on an instruction by the user. The intermediate image data is, for example, XPS data. The general-purpose printing program 41 further has a function of generating, based on the intermediate image data, print data in a format executable in printing by each of printers. The print data is, for example, PWGRaster data or PDF data. Moreover, the general-purpose printing program 41 has a function of transmitting the generated print data to a printer designated as a device performing printing through a communication function by the OS 21.

The supporting program 42 is a program or a program group configured to execute processes based on an instruction from the OS 21, and the execution by the supporting program 42 is accompanied by execution of processes by the general-purpose printing program 41. The supporting program 42 is a program configured to support a control of hardware which is to be controlled. The supporting program 42 of the present embodiment conforms to the model of the printer 2 connected to the PC 1, and, for example, the supporting program 42 is provided by a vendor of the printer 2. The general-purpose printing program 41 activates the general-purpose supporting program 42 conforming to the printer 2 in response to receiving a selection of the printer 2 as the device performing printing, in response to receiving an instruction of detailed print settings in a state in which the printer 2 is being selected, and in response to receiving an instruction for causing the printer 2 to print, and so on. The supporting program 42 is called as a print supporting application, the abbreviated name of which is PSA, or a hardware supporting application, the abbreviated name of which is HSA, for example.

It is noted that the supporting program 42 may be a combination of a plurality of programs each receiving an execution order, and the supporting program 42 may be a single program capable of executing different processes in accordance with different orders. Moreover, the supporting program 42 may be a program provided for each of various types of printers by the vendor of the printers. For example, each of a supporting program for an ink-jet printer and a supporting program for a laser printer may be provided. The supporting program is not limited to be provided for each of the various types of the printer, that is, a supporting program may be provided for each of the various kinds of models of the printers or may be provided for each of a plurality of series of the various kinds of models of the printers.

For example, in a case where a new printer is connected to the PC 1, the OS 21 of the PC 1 can download a suitable supporting program from a server of the vendor of the printer and so on and install the downloaded supporting program on the PC 1 in accordance with a type and a model of the connected printer. The OS 21 associates identification information of the installed supporting program 42 with information of the newly connected printer and stores the associated identification information of the supporting program 42 into the memory 12.

The editing application 43 is a program for, for example, performing generating and editing image data and document data. The editing application 43 may be, for example, WORD or PowerPoint each by Microsoft, or a program provided by the vendor of the printer 2. Each of WORD and PowerPoint is a registered trademark. The editing application 43 is capable of receiving, for example, a print execution instruction that causes the printer 2 to print through the user IF 13. It is noted that the editing application 43 is not limited to the program for performing generating and editing the data, and the editing application 43 may be a program having a function of receiving, in response to an instruction of the user, an instruction for displaying or printing various kinds of information such as map information or a web page.

As illustrated in FIG. 1, the PC 1 in the present embodiment is connected to the printer 2 thought the communication IF 14. The printer 2 is a device having at least a print function and a communication function. For example, in a case where the printer 2 receives print data from the PC 1 or the like, the printer 2 is capable of performing printing based on the received print data. The printer 2 may be a printer capable of performing color printing, and may be a printer capable of performing only monochrome printing.

Next, there will be described steps of causing the printer 2 to print in the PC 1 of the present embodiment. It is noted that each processing in the present embodiment basically indicates processing of the CPU 11 in accordance with instructions described in programs such as the supporting program 42. The processing by the CPU 11 includes a hardware control by using API of the OS 21. In the present application, there will be described operations of each of the programs, and a detailed explanation of the OS 21 is dispensed with. Moreover, “obtainment” is used as a concept not requiring a request.

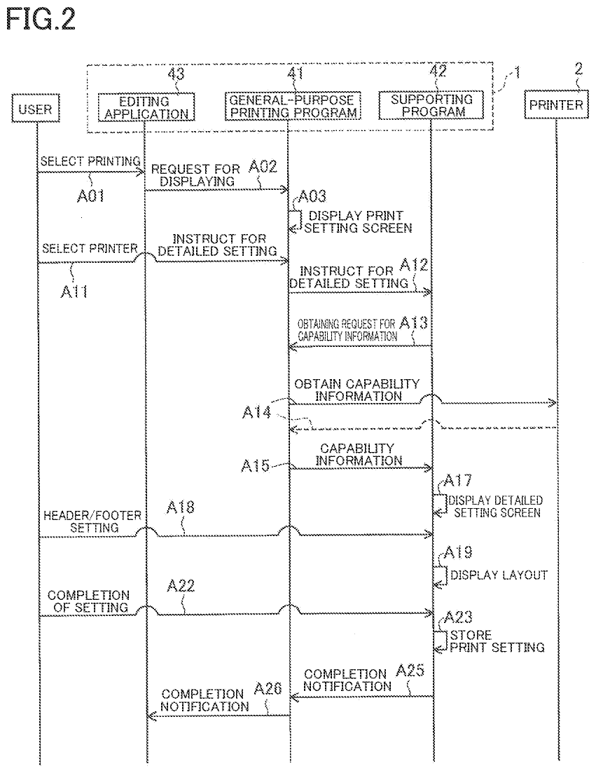

First, there will be described steps of print setting for receiving an instruction of the print setting by the user with reference to a view of a sequence in FIG. 2. The editing application 43 receives generation and edit of the document or the image based on the instruction by the user. In a case where the user wishes to print the document or the image each being displayed, the user selects printing in the editing application 43 (A01). The user can select printing in, for example, a menu of operation items provided in the editing application 43.

When the editing application 43 receives the selection of printing, the editing application 43 makes a request to the general-purpose printing program 41 of the OS 21 for displaying a screen in which the general-purpose printing program 41 receives an instruction related to printing (A02). In response to receiving the request, the general-purpose printing program 41 displays a print setting screen on the user IF 13 (A03). The print setting screen is a screen that receives the instruction, by the user, for various kinds of print settings which are available for the general-purpose printing program 41. It is noted that the editing application 43 may display the print setting screen.

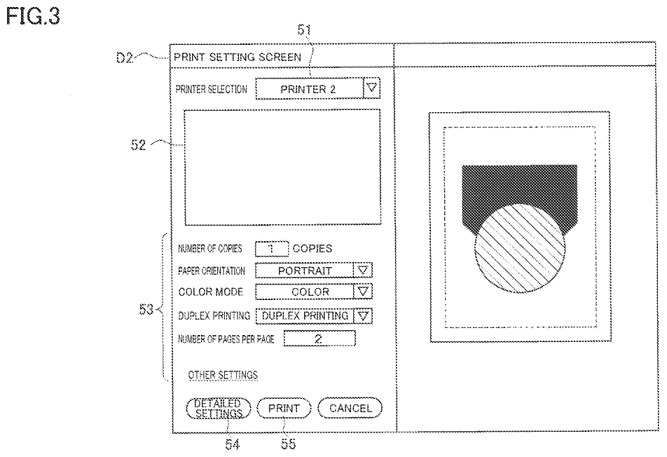

There will be illustrated an example of the print setting screen in FIG. 3. A print setting screen D2 of the example in FIG. 3 includes a printer selecting column 51, an information displaying area 52, a basic-print-setting selection area 53, a detailed setting button 54 and a printing button 55. The printer selecting column 51 is a column that receives a selection of a device performing printing. The information displaying area 52 is a column in which information designated by the supporting program 42 comforming to the device selected in the printer selecting column 51 is displayed. For example, in a case where the selectin of the printer 2 is received in the printer selecting column 51, or in a case where the instruction for printing is received in a state in which the printer 2 is set to the printer usually used in the OS 21, the general-purpose printing program 41 activates the supporting program 42 and can display an image prepared by the supporting program 42 in the information displaying area 52.

The basic-print-setting selection area 53 is a column that receives basic settings such as the number of printing, the orientation of the document. The detailed setting button 54 is a button that receives an instruction for performing detailed settings not included in the basic-print-setting selection area 53. The printing button 55 is a button that receives an execution instruction for printing with the selected print settings.

For example, in a case where the instruction for the detailed print settings is received by the operation to the detailed setting button 54 in a state in which the printer 2 is being selected as the device performing printing in the printer selecting column 51 (A11), the general-purpose printing program 41 passes an instruction for causing the supporting program 42 conforming to the printer 2 to start receiving the detailed print settings (A12).

When being activated in response to receiving the instruction at A12, the supporting program 42 obtains capability information of the printer 2. Specifically, the supporting program 42 make the request to the general-purpose printing program 41 for an obtainment of the capability information (A13). The general-purpose printing program 41 transmits the obtainment request for the capability information to the printer 2, and obtains the capability information from the printer 2 (A14). In a case where the printer 2 receives the obtainment request for the capability information transmitted from the PC 1, the printer 2 transmits the capability information including own information to the PC 1. The general-purpose printing program 41 passes the obtained capability information to the supporting program 42 (A15). As a result of this, the supporting program 42 can obtain the capability information of the printer 2. The process at A13-A15 is an example of an obtaining process.

It is noted that the general-purpose printing program 41 communicates with the printer 2 over communication in accordance with, for example, the IPP (an abbreviation of Internet Printing Protocol) through the OS 21 at A14. It is noted that the supporting program 42 may directly obtain the capability information from the printer 2 by using, for example, MIB (an abbreviation of Management Information Base) instead of making the requesting of the general-purpose printing program 41 for the obtainment of the capability information.

The capability information obtained from the printer 2 includes parameter information settable as print settings and device-information stored in the printer 2. The capability information may further include, for example, remaining amount of consumables, information related to selectable trays mounted on the printer, sheet information related to sheets set on each of the trays, and information related to executable printing resolutions. Moreover, the printer 2 may have a function of performing image processing based on a received print job and printing based on the image-processed data, for example, a function of performing page-layout printing such as N in 1, a function of performing composite printing such as watermarking, and a function of performing saving printing for saving coloring agents. In a case where the printer 2 has the function of the image processing executable by the printer 2, the printer 2 may pass the capability information including information of the function of the image processing. Moreover, the printer 2 may pass the capability information including information indicating own status.

The device-information stored in the printer 2 includes, for example, the printer information, font information, specific-character information and specific-image information. The printer information is information configured to identify the printer 2, and includes, for example, at least one of the name of the printer, the name of the model of the printer, the serial number of the printer, the MAC address of the printer and the IP address of the printer. The font information is information indicating fonts included in the printer 2, for example, information indicating at least one of types of fonts, styles of fonts, sizes of fonts, character decorations, and colors of fonts.

Each of the specific-character information and the specific-image information is information indicating image data of the characters or the images stored in the printer 2, for example, information indicating at least one of pictograms, logos, icons, symbol marks. The image data of the characters or the images stored in the printer 2 is an example of device-image data. It is noted that the printer 2 may store image data indicating any text or any images as the specific-character information or the specific-image information in response to the operation by the user. In a case where the printer 2 stores any image data, the printer 2 may transmit the image data as the device-information so as to be included in the capability information.

The supporting program 42 causes the PC 1 to display a detailed-setting screen that receives the detailed print setting on the user IF 13 based on the obtained capability information (A17). Parameters executable by the printer 2 are included as choices in the detailed-setting screen displayed by the supporting program 42. The supporting program 42 is capable of receiving the operation by the user to the detailed-setting screen being displayed. It is noted that, since there is a lot of items of print settings which can be received in the detailed-setting screen, the supporting program 42 may receive an instruction for switching items to be selected by, for example, a plurality of tabs.

The supporting program 42 can receive, for example, an instruction for adding various kinds of information as a header, a footer, or both the header and the footer to an image to be printed based on the operation by the user. The header is information arranged in a header area located at an upper part of a page, and the footer is information arranged in a footer area located at a lower part of a page.

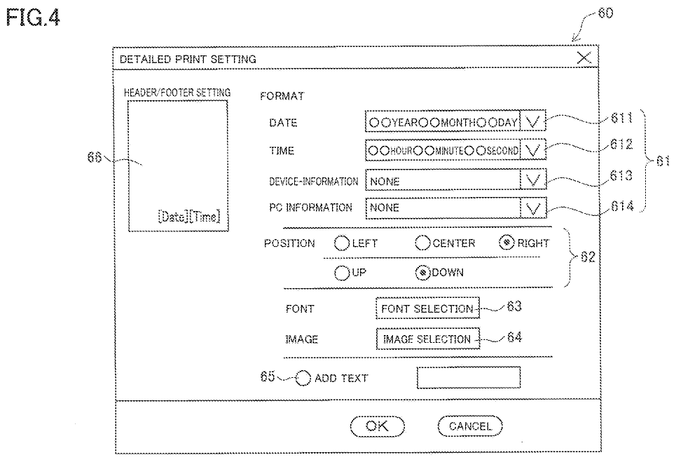

The supporting program 42 can display, for example, a header/footer setting screen 60 illustrated in FIG. 4 as a screen that receives the detailed print settings on the user IF 13 at A17. The header/footer setting screen 60 is a screen capable of receiving a setting of the header, a setting of the footer, or settings of the header and the footer, and the header/footer setting screen 60 is an example of a setting screen. The header/footer setting screen 60 illustrated in FIG. 4 includes a form setting column 61, a position setting column 62, a font selecting button 63, an image selecting button 64, a text adding button 65 and a layout image 66.

The form setting column 61 of the header/footer setting screen 60 illustrated in FIG. 4 includes a date setting column 611, a time setting column 612, a device-information setting column 613 and a PC-information setting column 614. The date setting column 611 is a column that receives a setting of whether a date is printed or not as the header or the footer, and a setting of a form of the date in case of printing the date. The time setting column 612 is a column that receives a setting of whether a time is printed or not as the header or the footer, and a setting of a form of the time in case of printing the time. Each of the date and the time is an example of conversion-designating information in which information included in the PC 1 is converted into a predesignated text, and an example of added-information.

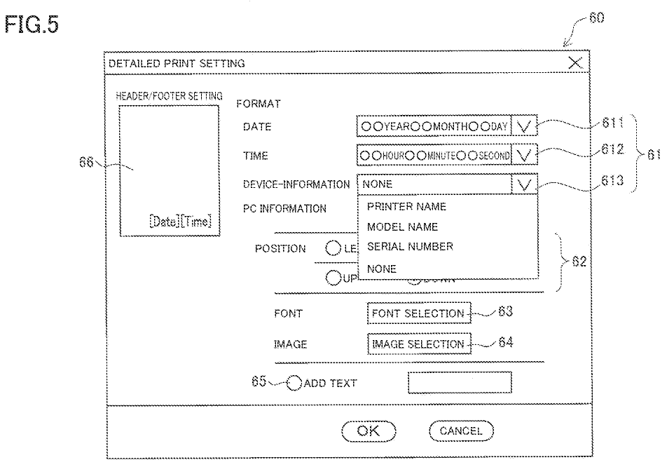

The device-information setting column 613 is a column that receives a setting of whether the printer information included in the device-information of the printer 2 is printed or not as the header or the footer, and a selection of information to be printed when the printer information is printed. When the supporting program 42 receives the operation to the device-information setting column 613, for example, as illustrated in FIG. 5, the supporting program 42 becomes capable of receiving the selection of the printer information to be included in the image to be printed as the header or the footer. The supporting program 42 may display, as choices, only the obtained printer information as the device-information, and may display, as choices, all of the plurality of pieces of printer information respectively having possibilities to be included in the device-information. In a case where the printer information which is not included in the device-information is selected, the supporting program 42 may cause an image indicating the selected print information is not included in the device-information to be included in the image to be printed.

It is noted that a case where the selection of one of the plurality of pieces of printer information is received is illustrated in FIG. 5, however, the supporting program 42 may display the plurality of pieces of printer information side by side. In this case, the supporting program 42 may receive the selection of whether the printer information is to be printed or not for each of the plurality of pieces of printer information. Moreover, the printer information to be printed as the header or the footer may be the printer information itself, and may be information generated by adding some processing to the printer information.

Moreover, the PC-information setting column 614 in the header/footer setting screen 60 is a column that receives a setting of whether PC information which is information can be obtained by the PC 1 itself is to be printed or not as the header or the footer, and a selection of information to be printed when the PC information is printed. The information can be obtained by the PC 1 is, for example, the file name and the folder name of the file to be printed, the PC identifying information for identifying the PC 1, the login name of the user when the login to the PC 1 by the user is received, and the page number of each of the pages. The PC information is an example of conversion-designating information in which information provided in the PC 1 is converted into a predesignated text, and an example of added-information.

Moreover, the position setting column 62 in the header/footer setting screen 60 illustrated in FIG. 4 is a column that receives a setting of a print position when printing the header or the footer. It is noted that an example in which only one of the header and the footer is printed and a predetermined one position of a plurality of positions in the page is selected is illustrated in FIG. 4. However, the supporting program 42 may respectively print both the header and the footer, and, in this case, the supporting program 42 may separately receive the selections of the position of the header and the position of the footer. Moreover, in a case where a plurality of pieces of information are printed as the header or the footer, the supporting program 42 may receive the selection of the position of each of the plurality of pieces of information to be printed.

Moreover, the font selecting button 63 in the header/footer setting screen 60 is a button that receives an instruction for selecting the type of the font in a case where the header, the footer, or both the header and the footer is printed by using the font stored in the printer 2. In response to receiving the operation to the font selecting button 63, the supporting program 42 receives the selection of the type of the font based on the font information included in the device-information of the printer 2. It is noted that, in a case where the number of types of the fonts stored in the printer 2 is only one, the supporting program 42 may receive the selection of whether printing by using the only one type of the font stored in the printer 2 is performed or not as the header, the footer, or both the header and the footer.

Moreover, the image selecting button 64 in the header/footer setting screen 60 is a button that receives an instruction for selecting the image in a case where the header, the footer, or both the header and the footer is printed by using at least one piece of image data of a plurality of pieces of image data stored in the printer 2. In response to receiving the operation to the image selecting button 64, the supporting program 42 receives the selection of the type of the image to be included in the header, the footer, or both the header and the footer based on the specific-character information and the specific-image information included in the device-information of the printer 2. It is noted that, in a case where the number of pieces of the image data stored in the printer 2 is only one, the supporting program 42 may receive the selection of whether the only one piece of image data is printed or not as the header, the footer, or both the header and the footer.

Moreover, the text adding button 65 in the header/footer setting screen 60 is a button that receives a setting of whether any text which can be inputted by the user is printed or not as the header or the footer. In response to receiving an instruction for printing any text by the text adding button 65, the supporting program 42 can receive the input of text to be added through the user IF 13.

Moreover, the layout image 66 of the header/footer setting screen 60 is an image indicating a type of information to be printed and an arrangement of the plurality of pieces of information in a case where an instruction for printing the header or the footer is received. Since the user can check the arrangement of the plurality of pieces of the information by the layout image 66, it is possible to reduce the possibility of unintended printing of the user. It is noted that the layout image 66 may not include the information of the text as far as the layout image 66 indicates at least the arrangement of the set header or the set footer.

The supporting program 42 can receive the selection of the information to be printed as the header, the footer, or both the header and the footer among the device-information stored in the printer 2 and the information of the PC 1 through the header/footer setting screen 60. Especially, since the supporting program 42 can receive the selection of the printer information to be printed as the header or the footer among the plurality of pieces of printer information stored in the printer 2, flexibility of the header and the footer is high. Moreover, since the supporting program 42 can receive the input of the information of any text to be printed as the header, the footer, or both the header and the footer by the text adding button 65, flexibility of the header and the footer is high. It is noted that the supporting program 42 may receive the selection of a background color of the header and the footer.

Further, since the supporting program 42 receives the selection of the type of the font of the plurality of types of the fonts stored in the printer 2, it is possible to print the device-information as the header, the footer, or both the header and the footer by using the suitable font for the printer 2. Moreover, since the supporting program 42 receives the selection of the image data to be printed as the header, the footer, or both the header and the footer among the plurality pieces of image data stored in the printer 2, it is possible to improve flexibility of the header, the footer, or both the header and the footer. It is noted that, in a case where image data indicating a size of the image beyond the space of the header area or the space of the footer area is selected, the supporting program 42 may limit the selection of the image data, or may give a warning of the possibility of overlapping of the image printed as the header or the footer on an image to be printed.

Back to the description of the print setting steps in FIG. 2. The supporting program 42 receives the setting of the header and the setting of the footer by the user through the header/footer setting screen 60 which is being displayed at A18 after displaying the header/footer setting screen 60 at A17. The process at A18 is an example of a receiving process.

The supporting program 42 causes the PC 1 to display the image indicating the arrangement of the plurality of pieces of the information in the page as the layout image 66 based on the setting received by the form setting column 61, the position setting column 62 and so on in the header/footer setting screen 60 (A19). The process at A19 is an example of a layout displaying process.

Further, the user can instruct for fixing the print setting and completing the setting by operating “OK button” in the detailed-setting screen such as the header/footer setting screen 60. When the supporting program 42 receives the input of the instruction for completing the detailed setting by the user (A22), the supporting program 42 ends the display of the detailed-setting screen and stores the information of the received print setting (A23).

For example, in a case where receiving the setting of the header, the footer, or both the header and the footer in the header/footer setting screen 60, the supporting program 42 stores header information indicating the setting of the header and footer information indicating the setting of the footer each received at A23 into the memory 12. It is noted that, in a case where the supporting program 42 does not receive the setting of the header and the setting of the footer, the supporting program 44 may store information indicating the supporting program 44 does not receive any setting as the header information and the footer information.

And, the supporting program 42 notifies the general-purpose printing program 41 of the completion of receiving the detailed print settings (A25). The general-purpose printing program 41 notifies the editing application 43 of the completion of the print setting based on the notification from the supporting program 42 (A26). The supporting program 42 may notify the editing application 43 of the completion of receiving the print setting. The editing application 43 makes the print setting screen, for example, the print setting screen D2 illustrated in FIG. 3 and displayed at A03, active, and the editing application 43 becomes a state in which the editing application 43 can receive instructions by the user such as the print execution instruction and an instruction for cancelling print.

It is noted that, as described above, the print setting screen D2 (see FIG. 3) includes the information displaying area 52 capable of displaying images prepared by the supporting program 42. Moreover, in a case where the general-purpose printing program 41 receives the operation to the information displaying area 52, the general-purpose printing program 41 passes the information of the operation to the supporting program 42. Then, the supporting program 42 causes the PC 1 to display, for example, information screen capable of receiving the setting of the header, the footer, or both the header and the footer in the information displaying area 52, and the supporting program 42 can receive the instruction for the setting of the header, the footer, or both the header and the footer by the instruction to the information displaying area 52 by the user. Also, in a case where the supporting program 42 receives the operation through information displaying area 52, the supporting program 42 may receive the setting of the header and the setting of the footer by displaying, for example, the screen illustrated in FIG. 4.

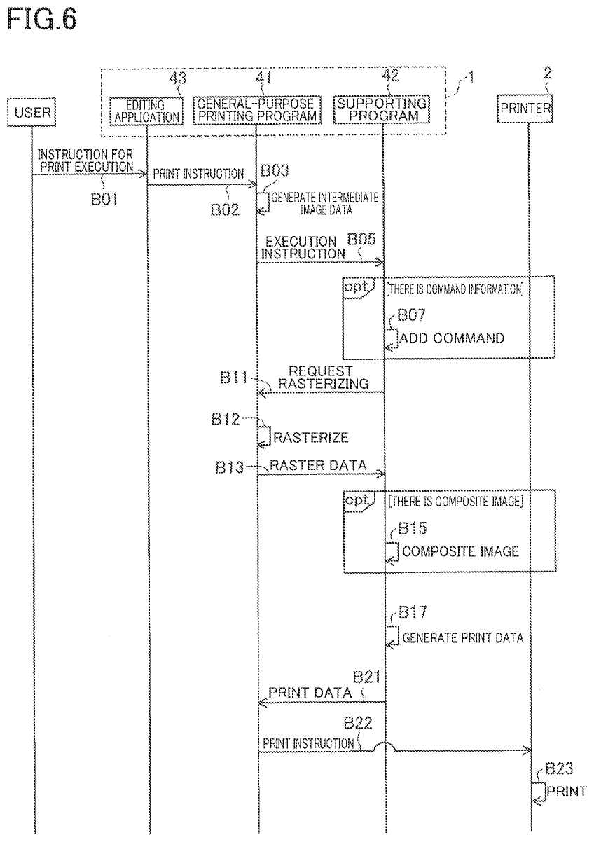

Next, there will be described steps of print execution with reference to a view of a sequence illustrated in FIG. 6. The user inputs an instruction for the print execution in the editing application 43 (B01) after fixing the image to be printed and the print setting in the printer 2. In a case where the editing application 43 receives, for example, the operation to the printing button 55 in the print setting screen D2 illustrated in FIG. 3, the editing application 43 determines that the editing application 43 receives an execution instruction to the general-purpose printing program 41 for causing the printer 2 to perform printing the image which is being selected in the editing application 43.

The editing application 43 passes the information of the received print execution to the general-purpose printing program 41 (B02). The general-purpose printing program 41 obtains, as the information of the print instruction, the image data indicating the image to be printed and the information indicating the print setting from the editing application 43.

The general-purpose printing program 41 generates the intermediate image data based on the obtained information from the editing application 43 by converting a format of the image data of the image to be printed into a format of the intermediate image data (B03). The image data included in the editing application 43 has various types of formats, the general-purpose printing program 41 converts the image data to be printed into the intermediate image data suitable for generating print data. It is noted that, in a case where the image data to be printed is suitable for generating print data, the image data to be printed itself may be used as the intermediate image data without generating the intermediate image data.

It is noted that, before generating the intermediate image data, the general-purpose printing program 41 may activate the supporting program 42 conforming to the printer 2 which is the designated device, and may notify the supporting program 42 of the start of the process of print job. In a case where the supporting program 42 is activated by the general-purpose printing program 41, the supporting program 42 can pass information indicating various kinds of instructions used when the intermediate image data is generated to the general-purpose printing program 41 as needed.

After generating the intermediate image data, the general-purpose printing program 41 activates the supporting program 42 (B05). The supporting program 42 can obtain the intermediate image data generated by the general-purpose printing program 41 by making the request to the general-purpose printing program 41. Then, the supporting program 42 edits the intermediate image data and the information of the print setting each received from the general-purpose printing program 41 based on the print setting stored at A23 in FIG. 2. In a case where the supporting program 42 receives, for example, the setting of the header, the setting of the footer, or the settings of the header and the footer as the print setting, the supporting program 42 may embed a command into the intermediate image data.

For example, in a case where receiving the setting indicating using the font included the printer 2 by the font selecting button 63 in the header/footer setting screen 60 (see FIG. 4), or in a case where receiving the setting indicating using the image data included in the printer 2 by the image selecting button 64, the supporting program 42 determines that the supporting program 42 adds the command to the intermediate image data. In a case where it is determined there is information for adding the command (opt: [THERE IS COMMAND INFORMATION]), the supporting program 42 adds the command to the intermediate image data based on the information of the print setting (B07). The process at B07 is an example of an adding process. The intermediate image data is image data in a vector format indicating the image to be printed.

The command is an instruction for causing the printer 2 to perform a predetermined operation. For example, in a case where receiving an instruction for using one of the plurality of types of the fonts included in the printer 2 as the header and the footer, the supporting program 42 passes, to the printer 2, the print instruction to which the command including the designation of the font and the designation of the text is added. Moreover, for example, in a case where receiving an instruction for using one of the plurality of images included in the printer 2 as the header and the footer, the supporting program 42 passes, to the printer 2, the print instruction to which the command including the designation of the image is added. In a case where receiving the print instruction including the command, the printer 2 can read information stored in the printer 2 and print in accordance with the instruction of the command.

The supporting program 42 passes the intermediate image data which has been edited to the general-purpose printing program 41, and makes a request to the general-purpose printing program 41 for rasterizing (B11). The general-purpose printing program 41 rasterizes the intermediate image data, and generates raster data which is bitmap data (B12). Further, the general-purpose printing program 41 passes the generated raster data to the supporting program 42 (B13). As a result of this, the raster data, which is the image data in the raster format indicating the image to be printed, is inputted to the supporting program 42 from the OS 21.

It is noted that the supporting program 42 may rasterize the intermediate image data instead of the general-purpose printing program 41. In this case, the supporting program 42 performs rasterizing based on the intermediate image data received by the instruction for the print execution, and generates the raster data. In a case where the supporting program 42 performs rasterizing, flexibility becomes higher than in a case where the general-purpose printing program 41 performs rasterizing. As a result of this, it is highly possible to generate the raster data suitable for printing in the printer 2. On the other hand, when the general-purpose printing program 41 performs rasterizing, amount of processes executed by the supporting program 42 decreases. Accordingly, it is possible to reduce a program size of the supporting program 42.

And, the supporting program 42 edits the raster data obtained at B13 based on the information of the print setting stored at A23 in the steps of the print setting (see FIG. 2). For example, in a case where the supporting program 42 receives the setting of the header, the setting of the footer, or the settings of the header and the footer as the print setting, the supporting program 42 may perform compositing an image with the raster data.

For example, in a case where receiving the setting in which the text indicating the various kinds of information is printed as the header or the footer through the form setting column 61 and the text adding button 65 in the header/footer setting screen 60 (see FIG. 4), the supporting program 42 determines that the supporting program 42 composites images. And, in a case where there is the image to be composite (opt: [THERE IS COMPOSITE IMAGE]), the supporting program 42 composites the image with the raster data based on the information of the print setting (B15). The process at B15 is an example of an adding process. Specifically, in a case where the header is set, the supporting program 42 composites the image of the header with the raster data, and in a case where the footer is set, the supporting program 42 composites the image of the footer with the raster data.

The processed raster data is encoded as PDL data by the supporting program 42, and the supporting program 42 generates the print data (B17). The print data generated at B17 is print data based on the image data to which the header information, the footer information, or both the header information and the footer information is added.

The supporting program 42 receives the setting of the header, the setting of the footer, or the settings of the header and the footer through the header/footer setting screen 60 by the user, and the supporting program 42 generates the print data to which the header information, the footer information, or both the header information and the footer information each reflecting the setting thereof is added. Accordingly, flexibility of the header and the footer is high.

It is noted that, in a case where the print setting includes the information indicating that the command is added to the print data, the supporting program 42 may add the command to the print data after generating the print data at B17, instead of adding the command to the intermediate image data at B07.

Moreover, in a case where the header, the footer, or both the header and the footer is set so as to be added, the supporting program 42 may display a preview image including the image to be printed and the image of the header or the footer which is being set on the user IF 13. The preview image is an example of a layout image, and the process of displaying the preview image is an example of a layout displaying process.

Further, the supporting program 42 passes the generated print data to the general-purpose printing program 41, and instructs the general-purpose printing program 41 to transmit the generated print data to the printer 2 (B21). The process at B21 is a process of causing the printer 2 to perform printing based on the image data to which the header information, the footer information, or both the header information and the footer information is added, and the process at B21 is an example of a printing process.

The print data passed to the general-purpose printing program 41 from the supporting program 42 at B21 may be data in a format printable by the printer 2. It is noted that the PDL data generated by the supporting program 42 may be data in a format printable by printers other than the model of the printer 2.

The general-purpose printing program 41 transmits the print data to the printer 2 and instructs the printer 2 to perform printing in accordance with the instruction from the supporting program 42 (B22). The printer 2 performs printing based on the received print data (B23). As a result of this, the printed matter is generated based on the print instruction outputted from the editing application 43.

It is noted that, at B21 in FIG. 6, the print data is passed to the general-purpose printing program 41, and the print data is transmitted from the general-purpose printing program 41 to the printer 2, instead, the supporting program 42 may transmit, to the printer 2, a print command that instructs for performing printing and the print data. For example, in a case where the setting related to the image processing executable by the printer 2 is included as the print setting, the supporting program 42 may generate a print command including information of the image processing. In this case, the supporting program 42 may notify the general-purpose printing program 41 of information indicating the completion of the transmitting after the completion of transmitting the print data.

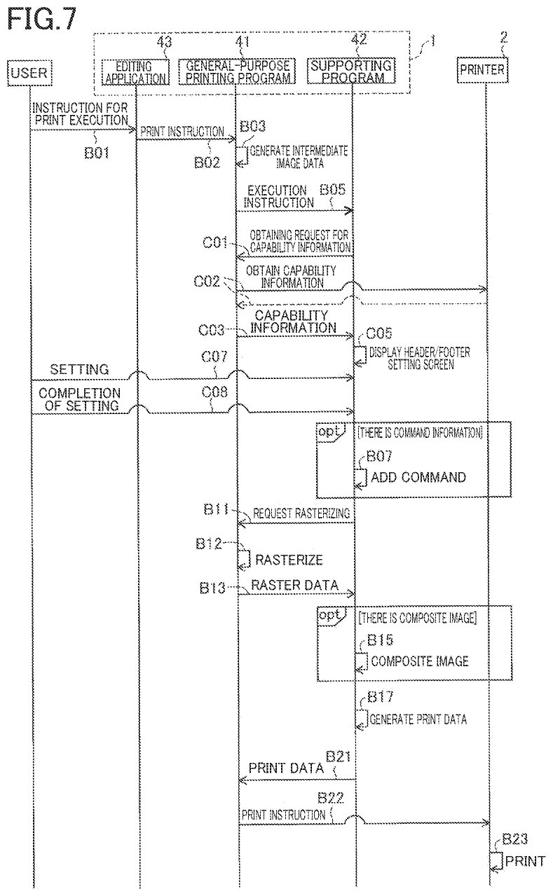

As described above, there was described the steps of the case where the setting of the header and the setting of the footer are received as the print setting before the instruction for print execution, and the information of the print setting including the information is stored. There will be next described steps of a case where an instruction for print execution is received in a state in which an instruction for the detailed print setting is not received with reference to a view of a sequence illustrated in FIG. 7. In the description below and FIG. 7, the same reference numerals as used in FIG. 6 are used to designate the corresponding steps in FIG. 7, and an explanation of which is dispensed with.

The editing application 43 receives the instruction for the print execution by the user (B01), and passes the print instruction to the general-purpose printing program 41 (B02). The general-purpose printing program 41 generates the intermediate image data (B03), and passes the execution instruction to the supporting program 42 (B05).

In response to receiving the print instruction of B05, the supporting program 42 obtains the capability information of the printer 2. Specifically, the supporting program 42 makes a request to the general-purpose printing program 41 for obtaining the capability information (C01), and obtains the capability information of the printer 2 (C03) through the general-purpose printing program 41 (C02). The processes at C01-C03 are the same as the processes at A13-A15 in the steps of the print setting (see FIG. 2). The process at C03 is an example of an obtaining process.

And, the supporting program 42 displays, for example, the header/footer setting screen 60 illustrated in FIG. 4 based on the device-information included in the obtained capability information (C05), and the supporting program 42 receives the setting by the user (C07). That is, the supporting program 42 may receive the setting of the header and the setting of the footer after receiving the execution instruction of B05 and before generating the print data. In this case, the user sets the setting of the header, the setting of the footer, or the settings of the header and the footer just before printing. Accordingly, it is possible to easily reflect the user's intention on printed matter when compared with the case where the setting is stored as the print setting after displaying the header/footer setting screen 60 by the user.

On the other hand, as described above, in a case where receiving the display instruction outputted from the editing application 43 (for example, A02 in FIG. 2), the supporting program 42 may receive the setting of the header and the setting of the footer. In this case, the user does not need to set the setting of the header and the setting of the footer at each printing. Accordingly, it is possible to reduce laborious work of the user when compared with the case where the setting screen is displayed at each printing.

In response to receiving the instruction for the completion of the setting by the user (C08), the supporting program 42 makes the request to the general-purpose printing program 41 for rasterizing, and, as described above, the supporting program 42 generates the print data to which the setting of the header or the setting of the footer is added (B13-B17). Further, the supporting program 42 transmits the generated print data to the printer 2 through the general-purpose printing program 41 (B21-B22). The printer 2 performs printing based on the received print data (B23).

It is noted that, in response to receiving the instruction at B05, the supporting program 42 may read the information of the print setting. In this case, in a case where the information of the print setting is not stored, the supporting program 42 may perform the processes at C01-C08. Moreover, the supporting program 42 may display the preview image based on the print data.

As described above in detail, the supporting program 42 of the present embodiment obtains the device-information from the printer 2, and adds, to the image data inputted from the OS 21, the header information, the footer information, or both the header information and the footer information for arranging the information based on the obtained device-information. Further, the supporting program 42 causes the printer 2 to perform printing based on the image data to which the header information, the footer information, or both the header information and the footer information is added. As a result of this, even in a case where the printer driver is not installed on the PC 1, it is possible to achieve the print function of the header or the footer using the device-information of the printer 2.

Next, there will be described below a second embodiment of the present disclosure with reference to drawings. It is noted that the same reference numerals as used in the first embodiment are used to designate the corresponding elements of the second embodiment, and an explanation of which is dispensed with.

When the supporting program 42 of the second embodiment is activated by the instruction of A12 in FIG. 2, the supporting program 42 obtains the capability information of the printer 2. Specifically, the supporting program 42 make a request to the general-purpose printing program 41 for obtaining the capability information (A13). The general-purpose printing program 41 transmits the obtainment request for the capability information to the printer 2, and obtains the capability information from the printer 2 (A14). The general-purpose printing program 41 passes the obtained capability information to the supporting program 42 (A15). As a result of this, the supporting program 42 can obtain the capability information of the printer 2.

In the second embodiment, the capability information obtained from the printer 2 includes parameter information which is settable as the print setting and font information stored in the printer 2. Further, the capability information may include, for example, remaining amount of consumables, information related to selectable trays mounted on the printer, sheet information related to sheets set on each of the trays, and information related to executable printing resolutions. Moreover, the printer 2 may have a function of performing image processing based on the received print job and printing based on the data which is processed by the image processing, that is, for example, a function of performing page-layout printing such as N in 1, a function of performing composite printing such as watermarking, and a function of performing saving printing for saving coloring agents. In a case where there is the function of the image processing executable by the printer 2, the printer 2 may pass the capability information including information of the function of the image processing executable by the printer 2. Moreover, the printer 2 may pass the capability information including information indicating own status.

In the second embodiment, the printer 2 previously stores a plurality of types of fonts executable in printing. And, in a case where the printer 2 receives the request for obtaining the capability information transmitted from the PC 1, the printer 2 transmits, to the PC 1, the capability information including the font information indicating the plurality of types of fonts stored in the printer 2 as the capability information including own information. The font information is information indicating fonts included in the printer 2, for example, information indicating at least one of types of fonts, styles of fonts, sizes of fonts, character decorations, and colors of fonts. The processes at A13-A15 of obtaining the capability information of the font information are examples of an obtaining process

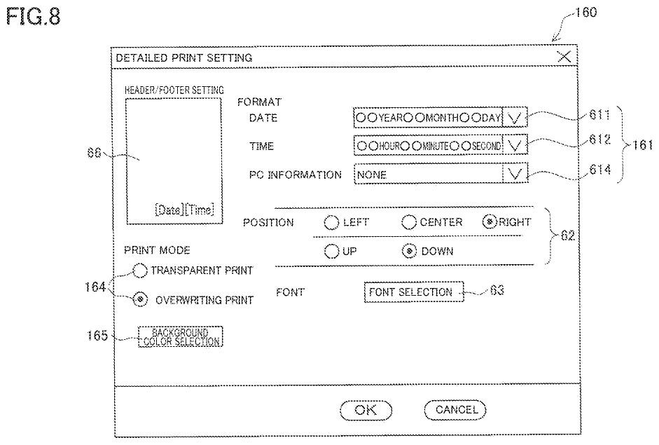

In the second embodiment, at A17 in FIG. 2, the supporting program 42 can display, for example, a header/footer setting screen 160 illustrated in FIG. 8 as a screen that receives the detailed print settings on the user IF 13. The header/footer setting screen 160 is a screen capable of receiving the setting of the header, the setting of the footer, or the settings of the header and the footer, and the header/footer setting screen 160 is an example of a setting screen. The header/footer setting screen 160 illustrated in FIG. 8 includes the form setting column 61, the position setting column 62, the font selecting button 63, a print mode selecting button 164, a background-color selecting button 165 and the layout image 66.

A form setting column 161 of the header/footer setting screen 160 illustrated in FIG. 8 includes the date setting column 611, the time setting column 612, and the PC-information setting column 614. The date setting column 611 is the column that receives the setting of whether a date is printed or not as the header or the footer, and the setting of the form of the date in case of printing the date. The time setting column 612 is the column that receives the setting of whether a time is printed or not as the header or the footer, and the setting of a form of the time in case of printing the time.

Moreover, the position setting column 62 in the header/footer setting screen 160 illustrated in FIG. 8 is a column that receives a setting of the arrangement of the information in printing in the case where receiving the setting indicating that the information is printed as the header or the footer. The information of the arrangement received by the position setting column 62 is an example of layout information.

It is noted that an example in which only one of the header and the footer is printed and one position of a plurality of positions in the page is selected is illustrated in FIG. 8. However, the supporting program 42 may respectively print both the header and the footer, and, in this case, the supporting program 42 may separately receive the selections of the position of the header and the position of the footer. Moreover, in the case where the plurality of pieces of information are printed as the header or the footer, the supporting program 42 may receive the selection of the layout of each of the plurality of pieces of information to be printed.

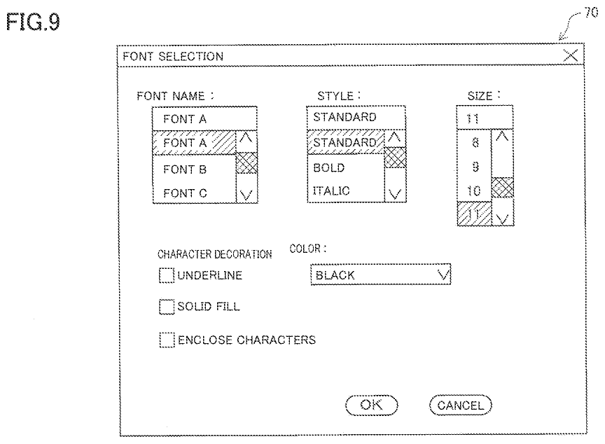

Moreover, the font selecting button 63 of the header/footer setting screen 160 is the button that receives the instruction for selecting the type of the font based on the font information obtained from the printer 2. In response to receiving the operation to the font selecting button 63, the supporting program 42 displays, for example, a font selecting screen 70 on the user IF 13, as illustrated in FIG. 9, and receives the selection of the type of the font by the user's operation. The supporting program 42 is capable of receiving, for example, the selection of the type of the font, the selection of the style of the font, the selection of the size of the font, the selection of the character decoration, and the selection of the colors of the font in the font selecting screen 70.

The supporting program 42 sets text information indicating text to be printed as the header, the footer, or both the header and the footer based on the setting received by at least one of the date setting column 611, the time setting column 612 and the PC-information setting column 614 of the form setting column 161 in the header/footer setting screen 160. And, in a case where the text information is set, the supporting program 42 may receive the operation to the font selecting button 63. The user can set such that the text indicated by the text information set as the header, the footer, or both the header and the footer is printed with the font selected in the font selecting screen 70 by using the header/footer setting screen 160.

Since the supporting program 42 can receive the selection of the type of the font used for the added text as the header and the footer, it is possible to composite the text using the font selected by the user as the header or the footer. Especially, since the supporting program 42 receives the selection of the font based on the font information obtained from the printer 2, it is possible to composite the text using the font suitable for the printer 2 as the header or the footer. It is noted that the supporting program 42 may receive the selection of the type of the font stored in the PC 1. Moreover, the supporting program 42 may read the font information of the printer 2 from the supporting program 42 in a case where the supporting program 42 previously stores the font information of the printer 2, may read the font information from the server and so on, instead of obtaining the font information included in the capability information of the printer 2.

Moreover, the print mode selecting button 164 in the header/footer setting screen 160 is a button that receives a selection of a transparent print mode or an overwriting print mode in a case where an image indicated by the image data is displayed at the position of the header or the position of the footer. The transparent print mode is a mode of printing in which, in a case where the position of the header or the position of the footer overlaps the image, the text of the header or the text of the footer is printed so as to be overlaid on the image in a state in which the background of the header or the footer is made transparent. The overwriting print mode is a mode of printing in which, in the case where the position of the header or the position of the footer overlaps the image, the text of the header or the text of the footer is printed such that the image is painted out or solidly filled by the background color of the header or the footer in a state in which the background of the header or the footer is made nontransparent.

In a case where the printing mode is set to the overwriting print mode by the print mode selecting button 164, the supporting program 42 is capable of receiving the operation of the background-color selecting button 165. In response to receiving the operation to the background-color selecting button 165, the supporting program 42 displays, for example, a color chart, and receives the selection of the background color printed as the back ground of the position of the header or the position of the footer.

Moreover, the layout image 66 in the header/footer setting screen 160 is an image indicating the kind and the arrangement of the information to be printed in a case where the instruction for printing the header or the footer is received. The user can check the arrangement of the plurality of pieces of information by the layout image 66, and it is possible to reduce the possibility of the unintended printing of the user. Since the supporting program 42 displays the layout image 66 on the header/footer setting screen 160 that receives the print setting, it is possible to easily set the arrangement of the header or the footer by the user. It is noted that the layout image 66 may not include the information of the text as far as the layout image indicates at least the arrangement of the set header or the set footer.

It is noted that the supporting program 42 may further receive, for example, any text or a setting of printing information based on the capability information obtained from the printer 2 as the header or the footer. For example, in response to obtaining, as the capability information of the printer 2, a printer name of the printer 2, a model name of the printer 2, a serial number of the printer 2, MAC address of the printer 2, IP address of the printer 2, or the like, the supporting program 42 may receive a setting of printing the obtained information or information to which any processing is added based on the obtained information as the header or the footer.

Back to the description of the print setting steps in FIG. 2. The supporting program 42 receives the setting of the header and the setting of the footer by the user through the header/footer setting screen 160 which is being displayed (A18) after displaying the header/footer setting screen 160 at A17.

The supporting program 42 causes the PC 1 to display the image indicating the arrangement of the header and the footer in the page as the layout image 66 based on the setting received by the form setting column 161, the position setting column 62 and so on in the header/footer setting screen 160 (A19).

Moreover, the supporting program 42 can display the detailed-setting screen other than the header/footer setting screen 160 by, for example, switching tabs, and the supporting program 42 can receive an instruction for kinds of print settings other than the setting of the header and the setting of the footer. The supporting program 42 can receive, for example, a page-layout setting indicating whether a page-layout printing in which a plurality of images in a plurality of pages are reduced and printed in one sheet is performed or not.

In a case where receiving, for example, the page-layout setting as the print setting, the supporting program 42 stores, into the memory 12 at A23, information of the page-layout setting including information of the number of pages printed in one sheet.

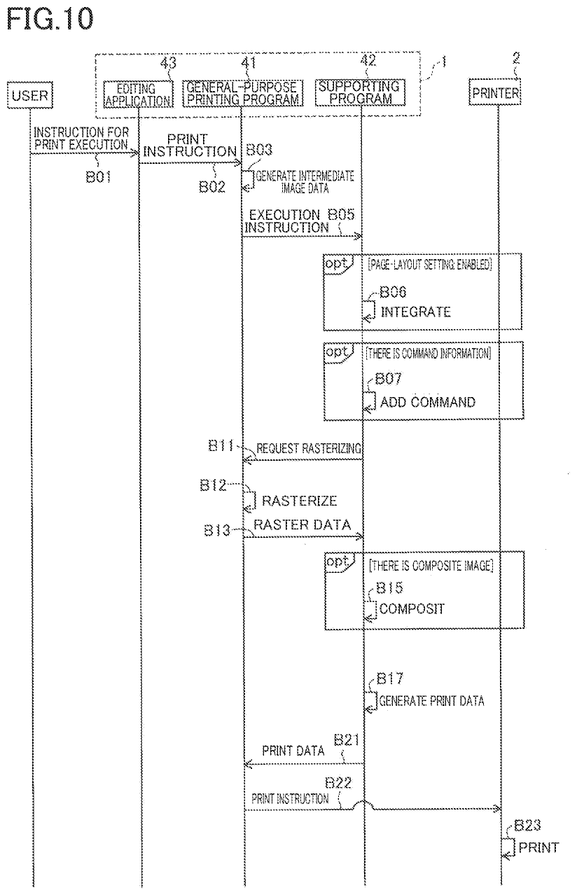

Next, there will be described steps of print execution with reference to a view of a sequence in FIG. 10. The user inputs an instruction for print execution by the editing application 43 after determining the image to be printed and the print setting for the printer 2 (0i1). In a case where receiving, for example, the operation to the printing button 55 in the print setting screen D2 illustrated in FIG. 3, the editing application 43 determines that the editing application 43 receives an execution instruction to the general-purpose printing program 41 for causing the printer 2 to perform printing the image which is being selected in the editing application 43.

The general-purpose printing program 41 activates the supporting program 42 (B05) after generating the intermediate image data at B03. The supporting program 42 can obtain the intermediate image data generated by the general-purpose printing program 41 by making the request to the general-purpose printing program 41. And, the supporting program 42 edits the intermediate image data received from the general-purpose printing program 41 and the information of the print setting based on the print setting stored at A23 in FIG. 2.

In a case where storing, for example, the page-layout setting as the print setting stored in the steps of print setting (see FIG. 2) at A23 (opt: [PAGE-LAYOUT SETTING IS ENABLED]), the supporting program 42 generates the intermediate image data for one page by integrating a plurality of pieces of intermediate image data for a plurality of pages (B06). The process at B06 is an example of a page-layout-generating process. The intermediate image data generated at B06 is an example of a page-layout image. It is noted that, in a case where the general-purpose printing program 41 has a function of integrating the plurality of pieces of image data, the supporting program 42 may instruct the general-purpose printing program 41 to integrate the plurality of pieces of image data.

Moreover, in a case where receiving, for example, the setting of the header, the setting of the footer, or the settings of the header and the footer as the print setting, the supporting program 42 may embed a command into the intermediate image data. For example, in a case where receiving the setting indicating using the font included the printer 2 by the font selecting button 63 in the header/footer setting screen 160 (see FIG. 8), the supporting program 42 determines that the supporting program 42 adds the command to the intermediate image data. In a case where it is determined that there is information for adding the command (opt: [THERE IS COMMAND INFORMATION]), the supporting program 42 adds the command to the intermediate image data based on the information of the print setting (B07).

It is noted that, at B7, the command is added to the intermediate image data separately from the image even in a case where the page-layout setting is received as the print setting. That is, the header and the footer are set in each sheet based on the setting by the user even in a case where the image data to which the command is added is the intermediate image data in which the plurality of images of the plurality of pages are integrated.

The command is a command that causes the printer 2 to perform a predetermined operation. For example, in a case where causing the printer 2 to print, as the header and the footer, a predetermined text by using one font included in the printer 2, the supporting program 42 passes, to the printer 2, an instruction for print execution to which the command including a designation of the font, a designation of the text and a designation of the layout is added. In a case where receiving the print instruction including the command, the printer 2 can read the information of the font stored in the printer 2 based on the instruction of the command, can print the designated text at the designated position.

For example, in a case where receiving the setting in which the text indicating various kinds of information is printed as the header or the footer through the form setting column 161 in the header/footer setting screen 160 (see FIG. 8), the supporting program 42 determines that the supporting program 42 composites images. And, in a case where there is the image to be composite (opt: [THERE IS COMPOSITE IMAGE]), the supporting program 42 composites the image with the raster data based on the information of the print setting (B15). Specifically, in a case where the header is set, the supporting program 42 composites the image of the header with the raster data, and in a case where the footer is set, the supporting program 42 composites the image of the footer with the raster data.

It is noted that, in a case where the page-layout setting is received as the print setting and the intermediate image data in which the plurality of images in the plurality of pages are integrated is generated at B06, the raster data integrated based on the integrated intermediate image data is generated at B12. The supporting program 42 composites the image with the integrated raster data at B15. That is, the header and the footer are arranged in each sheet based on the setting by the user even in a case where the image data is the integrated data.

It is noted that, in a case where receiving the page-layout setting as the print setting, the supporting program 42 may add the header and the footer to each of the plurality of images of the plurality of pages, instead of adding the header and the footer to the integrated image. Moreover, in a case where receiving both the page-layout setting and the setting of the header or the setting of the footer, the supporting program 42 may receive a selection between a setting indicating the header and the footer are added to each page, and a setting indicating the header and the footer are added to each sheet.

Moreover, in a case where adding the header, the footer, or both the header and the footer is set, the supporting program 42 may display, on the user IF 13, a preview image including the image to be printed and the image of the header or the footer which is being set. In a case where the preview image is displayed just before printing, the user can finally check the image to be printed to which the header, the footer, or both the header and the footer is added.

Further, also in the second embodiment, as illustrated in FIG. 7, the supporting program 42 displays, for example, the header/footer setting screen 160 illustrated in FIG. 8 based on the obtained capability information (C05), and the supporting program 42 receives the setting by the user (C07). That is, the supporting program 42 may receive the setting of the header and the setting of the footer after receiving the execution instruction of B05 and before generating the print data. As a result of this, the user sets the setting of the header, the setting of the footer, or the settings of the header and the footer just before printing. Accordingly, it is possible to easily reflect the user's intention on printed matter when compared with the case where the setting is stored as the print setting after displaying the header/footer setting screen 160 by the user.

It is noted that, in response to receiving the instruction at B05, the supporting program 42 may read the information of the print setting. In this case, in a case where the information of the print setting is not stored, the supporting program 42 may perform the processes at C01-C08. Moreover, the supporting program 42 may display the preview image based on the print data. It is noted that, also in this case, the supporting program 42 may add the header or the footer to the integrated raster data as far as the page-layout setting is received as the print setting.

As described above, the supporting program 42 of the present embodiment displays the header/footer setting screen 160 (see FIG. 8), and receives the information of the text and the information of the layout as the setting of the header, the setting of the footer, or the settings of the header and the footer. And, in a case where the print instruction, outputted from the editing application 43 to the general-purpose printing program 41, for causing the printer 2 to print the image is received and the image data indicating the image to be printed is inputted to the general-purpose printing program 41 from the OS 21, the supporting program 42 adds the header information, the footer information, or both the header information and the footer information to the image data, and causes the printer 2 to perform printing based on the image data to which the header information, the footer information, or both the header information and the footer information. As a result of this, even in a case where the printer driver is not installed on the PC 1, it is possible to achieve the print function of the header or the footer using the text set by the user.

It is noted that the embodiments disclosed in the present disclosure are merely described by way of examples, and do not limit the present disclosure. Accordingly, the technical features disclosed in the present disclosure may be embodied with various changes and modifications, which may occur to those skilled in the art, without departing from the spirit and scope of the disclosure. For example, the device connected on the PC 1 is not limited to the printer 2, and may be an apparatus having a printing function such as a multifunction peripheral, a copying apparatus, a facsimile apparatus. Moreover, the number of printers connected to the PC 1 is not limited to the example illustrated in drawings, may be two or more.

Moreover, for example, the example of the image displayed on the user IF 13 is an example, and the image is not limited to the example illustrated in the drawings. Moreover, the text, the shape of the object, the background of the object, and so on displayed in the image illustrated in each of the drawings may be changed as appropriate. Moreover, for example, the print setting screen D2 including a single information displaying area 52 is illustrated in FIG. 3, however, the arrangement of the information displaying area 52, the shape of the information displaying area 52, the size of the information displaying area 52, the number of the information displaying area 52, and so on are not limited to the example illustrated in FIG. 3. Moreover, the information displaying area 52 may be dispensed with.

Moreover, in the first embodiment, there is described the example in which the selection of the information of the obtained device-information which is added to the image data to be printed as the header and the footer is received, however, the selection may not be received. For example, the added device-information may be determined previously. In this case, the supporting program 42 may not receive the setting of the header and the setting of the footer, and may not perform displaying the header/footer setting screen 60 (see FIG. 4).

Moreover, in the second embodiment, for example, the supporting program 42 may not receive the selection of the type of the font as the information of the header and the footer. The supporting program 42 may add, for example, the text with the font included in the PC 1 as the header and the footer. In this case, the supporting program 42 may not obtain the information of the font from the printer 2.

Moreover, in the above described embodiments, the supporting program 42 is capable of setting not only the information based on the device-information, but also the PC information and any text as the header and the footer, however, the supporting program 42 may not be able to print the PC information and said any text. Moreover, the supporting program 42 may not be able to receive the selection of the type of the font and the selection of the image data as the information of the header and the footer.

Moreover, the supporting program 42 may not perform displaying the layout image. For example, the supporting program 42 may display the header/footer setting screen 60 (see FIG. 4) or the header/footer setting screen 160 (see FIG. 8) each not including the layout image 66. Moreover, the display order and the display arrangement of the items that receives the selection in the header/footer setting screen 60 or the header/footer setting screen 160 is not limited to the examples illustrated in the drawings.

Moreover, the general-purpose printing program 41 may activate the supporting program 42 in a case where the printer usually used in the OS 21 is switched from another printer to the printer 2 by operations of the user via the OS 21 after the print-setting screen D2 is displayed by the general-purpose printing program 41. In this case, the supporting program 42 may display, for example, an information screen that is capable of receiving an instruction related to the header and the footer on the information displaying area 52.

Moreover, not only in the case where printing is selected, but also, for example, in the case where the printer 2 is selected as the setting of the device, the supporting program 42 may be activated. Also in this case, the supporting program 42 may display a setting screen that is capable of receiving the setting of the header and the setting of the footer as a default print setting.

Moreover, in the present embodiments, as the operations of the supporting program 42, only printing operations are described in detail, however, the supporting program 42 may have other functions. Moreover, the program executing the processes of the present embodiments is not limited to the supporting program 42, and the program may be a program that receives an instruction from the OS 21 or the general-purpose printing program 41 when executing printing by using the general-purpose printing program 41. For example, the program may be a printing workflow application what is called Print Workflow, the specification of which is published by Microsoft.

Moreover, the execution timing of the supporting program 42 is not limited to the examples of the present embodiments. For example, the supporting program 42 may be executed by a direct instruction for executing from the OS 21, or the supporting program 42 may be a resident program. In a case where the supporting program 42 is the resident program, the supporting program 42 may perform the above described operations when receiving an execution command.

Moreover, in the any flowcharts disclosed in the present embodiments, the execution order of the plurality of processes in the plurality of any steps may be changed or the plurality of processes may be executed in parallel, as far as a contradiction of the processes does not occur.

Moreover, the processes disclosed in the present embodiments may be executed by hardware such as a single CPU, a plurality of CPUs, an ASIC, and a combination of the CPU, the plurality of CPUs and the ASIC. Moreover, the processes disclosed in the present embodiments may be embodied by various kinds of embodiments such as a storage medium storing a program executing the processes and methods.

What is claimed is:

1. A non-transitory storage medium storing a supporting program executable by a computer of an information processing apparatus,
wherein the supporting program is configured to support a printing program of an operating system of the information processing apparatus, the supporting program conforming to a printer connected to the information processing apparatus,
wherein, when executed by the computer, the supporting program causes the information processing apparatus to execute:
when image data indicating an image to be printed, based on a print instruction, is inputted from the printing program of the operating system in response to receiving the print instruction, outputted from an application program installed on the information processing apparatus, for causing the printing program of the operating system to perform printing the image by the printer,
adding header information, footer information, or both the header information and the footer information to the image data inputted from the operating system, and
causing the printer to perform printing based on the image data to which the header information, the footer information, or both the header information and the footer information is added.

2. The non-transitory storage medium according to claim 1,
wherein, when executed by the computer, the supporting program causes the information processing apparatus to execute obtaining device-information stored in the printer from the printer, and
wherein the header information added to the image data is information by which information based on the obtained device-information is arranged in a header area located at an upper part in a page, and the footer information added to the image data is information by which the information based on the obtained device-information is arranged in a footer area located at a lower part in the page.

3. The non-transitory storage medium according to claim 2,
wherein, when executed by the computer, the supporting program causes the information processing apparatus to execute displaying a layout image on a user interface of the information processing apparatus, the layout image indicating an arrangement of the information based on the device-information in the page.

4. The non-transitory storage medium according to claim 2,
wherein, when executed by the computer, the supporting program causes the information processing apparatus to execute displaying a setting screen on a user interface of the information processing apparatus and receiving a setting of a header, a setting of a footer, or settings of both the header and the footer through the setting screen, and
wherein the header information added to the image data is information by which the information based on the obtained device-information is arranged in accordance with the received setting of the header, and the footer information added to the image data is information by which the information based on the obtained device-information is arranged in accordance with the received setting of the footer.

5. The non-transitory storage medium according to claim 4,
wherein, when executed by the computer, the supporting program causes the information processing apparatus to execute obtaining the device-information of the printer from the printer before the setting screen is displayed,
wherein the obtained device-information includes font information related to a plurality of types of fonts stored in the printer, and
wherein the setting of the header, the setting of the footer, or the settings of the header and the footer received in the setting screen includes a selection of one of the plurality of types of fonts based on the font information.

6. The non-transitory storage medium according to claim 4,
wherein, when executed by the computer, the supporting program causes the information processing apparatus to execute obtaining the device-information of the printer from the printer before the setting screen is displayed,
wherein the obtained device-information includes a plurality of pieces of device-image data, which is image data stored in the printer, and
wherein the setting of the header, the setting of the footer, or the settings of the header and the footer received in the setting screen includes a selection of one of the plurality of pieces of the device-image data, which is printed as the header, the footer, or both the header and the footer.

7. The non-transitory storage medium according to claim 4,
wherein, when executed by the computer, the supporting program causes the information processing apparatus to execute obtaining the device-information of the printer from the printer before the setting screen is displayed,
wherein the obtained device-information includes a plurality of pieces of printer information capable of identifying the printer in which the printer information is stored, and
wherein the setting of the header, the setting of the footer, or the settings of both the header and the footer received in the setting screen includes a selection of one of the obtained plurality of pieces of printer information, which is printed as the header, the footer, or both the header and the footer.

8. The non-transitory storage medium according to claim 4,
wherein the setting of the header, the setting of the footer, or the settings of both the header and the footer received in the setting screen includes a selection of one of a plurality of pieces of added-information obtained by the information processing apparatus, which is printed as the header, the footer, or both the header and the footer,
wherein the added-information includes conversion-designating information converted into a predesignated text, any text inputted through the user interface of the information processing apparatus, or both the conversion-designating information and any text, and
wherein the header information is information by which the information based on the obtained device-information and the added-information selected in the setting screen are arranged in accordance with the received setting of the header, and the footer information is information by which the information based on the obtained device-information and the added-information selected in the setting screen are arranged in accordance with the received setting of the footer.

9. The non-transitory storage medium according to claim 4,
wherein, when executed by the computer, the supporting program causes the information processing apparatus to execute:
in response to receiving a displaying instruction of the setting screen outputted from the application program installed on the information processing apparatus, receiving the setting of the header, the setting of the footer, or the settings of the header and the footer through the setting screen, and storing the received setting of the header, the received setting of the footer, or the received settings of the deader and the footer into a memory of the information processing apparatus, and
in the adding, reading the setting stored in the memory, and adding, to the image data inputted from the operating system, the header information, the footer information, or both the header information and the footer information each arranging the information based on the obtained device-information in accordance with the setting read from the memory.

10. The non-transitory storage medium according to claim 4,
wherein, when executed by the computer, the supporting program causes the information processing apparatus to execute, in response to receiving the print instruction, receiving the setting of the header, the setting of the footer, or the settings of the header and the footer through the setting screen before the header information, the footer information, or both the header information and the footer information is added to the image data.

11. The non-transitory storage medium according to claim 2,
wherein, in response to receiving the print instruction, the image data in a vector format indicating the image to be printed by the print instruction is inputted from the operating system,
wherein the header information added to the image data, the footer information added to the image data, or both the header information and the footer information added to the image data is a command, and
wherein, in the adding, the command is embedded in the image data to which the header information, the footer information, or both the header information and the footer information is added.

12. The non-transitory storage medium according to claim 2,
wherein, in response to receiving the print instruction, the image data in a raster format indicating the image to be printed by the print instruction is inputter from the operating system, and
wherein, in the adding, the header information, the footer information, or the header information and the footer information is added to the image data in a state in which the information based on the device-information is written into the image indicated by the image data.

13. The non-transitory storage medium according to claim 2,
wherein, in the obtaining, the supporting program makes an obtaining instruction to the operating system for obtaining capability information of the printer and obtains the device-information included in the capability information inputted from the operating system in accordance with the obtaining instruction,
wherein, in response to receiving the obtaining instruction for obtaining the capability information, the operating system transmits a obtaining request for the capability information to the printer, and
wherein, in response to receiving the obtaining request from the information processing apparatus, the printer transmits the capability information including the device-information to the information processing apparatus.

14. The non-transitory storage medium according to claim 1,
wherein, when executed by the computer, the supporting program causes the information processing apparatus to execute displaying a setting screen on a user interface of the information processing apparatus and receiving a setting of a header, a setting of a footer, or settings of the header and the footer through the setting screen, and
wherein the setting of the header, the setting of the footer, or the settings of the header and the footer includes (i) text information indicating a text used as the header, or the footer, or both the header and the footer, and (ii) layout information indicating an arrangement of the text information, and
wherein the header information added to the image data is information by which the text indicated by the text information based on the received setting of the header is arranged in accordance with the layout information, the footer information added to the image data is information by which the text indicated by the text information based on the received setting of the footer is arranged in accordance with the layout information.

15. The non-transitory storage medium according to claim 14,
wherein the received setting of the header or the received setting of the footer includes a type of a font, and
wherein the header information added to the image data is information by which the text indicated by the text information in the font indicated by the type of font based on the received setting of the header is arranged in accordance with the layout information, the footer information added to the image data is information by which the text indicated by the text information in the font indicated by the type of font based on the received setting of the footer is arranged in accordance with the layout information.

16. The non-transitory storage medium according to claim 15,
wherein, when executed by the computer, the supporting program causes the information processing apparatus to execute:
obtaining, from the printer, font information indicating a plurality of types of fonts stored in the printer, and
wherein, in the receiving, receiving a selection of one of the plurality of types of fonts included in the obtained font information, and setting the received type of font to the font as the setting of the header or the setting of the footer.

17. The non-transitory storage medium according to claim 14,
wherein, when executed by the computer, the supporting program causes the information processing apparatus to execute displaying a layout image indicating the arrangement indicated by the layout information on the user interface.

18. The non-transitory storage medium according to claim 17,
wherein, when executed by the computer, the supporting program causes the information processing apparatus to execute, in response to receiving the print instruction and the image data indicating the image to be printed by the print instruction inputted from the operating system, displaying the layout image on the user interface before performing printing.

19. The non-transitory storage medium according to claim 17,
wherein, in the displaying the layout image, the setting screen including the layout image is displayed on the user interface.

20. The non-transitory storage medium according to claim 14,
wherein a page-layout setting is received in the setting screen, the page-layout setting indicating whether a page-layout printing in which a plurality of images in a plurality of pages are reduced and printed in one sheet is performed or not,
wherein, when executed by the computer, the supporting program causes the information processing apparatus to execute:
in response to receiving the print instruction and the image data inputted from the operating system, and in a case where the page-layout setting indicates that the page-layout printing is performed,
generating a page-layout image for the page-layout printing based on the image data inputted from the operating system, and
wherein, in the adding, adding the header information, the footer information, or the both the header information and the footer information to the generated page-layout image.

21. The non-transitory storage medium according to claim 14,
wherein, when executed by the computer, the supporting program causes the information processing apparatus to execute:
in response to receiving a displaying instruction outputted from the application program installed on the information processing apparatus, receiving the setting of the header, the setting of the footer, or the settings of the header and the footer through the setting screen, and storing the received setting of the header, the received setting of the footer, or the received settings of the deader and the footer into a memory of the information processing apparatus, and
in the adding, reading the setting stored in the memory, and adding, to the image data inputted from the operating system, the header information, the footer information, or both the header information and the footer information each arranging the text indicated by the text information based on the setting read from the memory in accordance with the layout information.

22. The non-transitory storage medium according to claim 14,
wherein, when executed by the computer, the supporting program causes the information processing apparatus to execute, in response to receiving the print instruction, receiving the setting of the header, the setting of the footer, or the settings of the header and the footer through the setting screen before the header information, the footer information, or both the header information and the footer information is added to the image data.

23. The non-transitory storage medium according to claim 14,
wherein, in response to receiving the print instruction, the image data in a vector format indicating the image to be printed by the print instruction is inputted from the operating system,
wherein the header information added to the image data, the footer information added to the image data, or the header information and the footer information added to the image data is a command, and
wherein, in the adding, the command is embedded in the image data to which the header information, the footer information, or both the header information and the footer information is added.

24. The non-transitory storage medium according to claim 14,
wherein, in response to receiving the print instruction, the image data in a raster format indicating the image to be printed by the print instruction is inputter from the operating system, and
wherein, in the adding, the header information, the footer information, or both the header information and the footer information is added to the image data in a state in which the text indicated by the text information based on the header information, the footer information, or both the header information and the footer information is written into the image indicated by the image data in accordance with the layout information.
